(19) United States
(12) Patent Application Publication
(10) Pub. No.: US 2016/0152213 A1
(43) Pub. Date: Jun. 2, 2016

(54) Vehicle Light Washing System

(71) Applicant: Baerg Innovations Inc., Beaverlodge (CA)

(72) Inventor: Jay Ryan Baerg, Beaverlodge (CA)

(21) Appl. No.: 14/936,790

(22) Filed: Nov. 10, 2015

Related U.S. Application Data
(60) Provisional application No. 62/085,381, filed on Nov. 28, 2014.

(51) Int. Cl. B60S 1/52

(52) U.S. Cl. CPC B60S 1/52

(57) ABSTRACT

A vehicle washing system uses a charge chamber gravity fed through a check valve from a wash fluid tank. A supply line connects the charge chamber to a compressed air supply. A discharge line connects the charge chamber to nozzles directed onto lights of the vehicle. First and second control valves are connected in series with the supply line and the discharge line respectively. The control valves are opened together so that a charge of compressed air from the compressed air supply pressurizes the charge chamber and discharges at least a portion of the prescribed quantity of wash fluid from the charge chamber through the nozzles. A pressure balancing passage balances pressure between the wash fluid tank and the charge chamber to allow the filling of the charge chamber under gravity through the check valve when the control valves are closed.

This application claims the benefit under 35 U.S.C. 119(e) of U.S. provisional application Ser. No. 62/085,381, filed Nov. 28, 2014.

### FIELD OF THE INVENTION

The present invention relates to a washing system for washing lights of a vehicle, for example the headlights of a commercial vehicle, and more particularly the present invention relates to a washing system in which an onboard compressed air supply system of the vehicle is used to supply charges of compressed air which direct respective portioned quantities of wash fluid through nozzles onto the lenses of the respective lights.

### BACKGROUND

Especially in northern climates with frequent snowfall and road spray, it becomes necessary to wash the vehicle's headlights at relatively short intervals to maintain safe visibility. Also HID and LED headlights, do not create enough heat to melt the snow from the lens surface, allowing snow and ice to accumulate, thereby greatly reducing the effectiveness of the lights.

Various examples for washing the lenses of vehicular lights using washer fluid directed by compressed air are disclosed in U.S. Pat. No. 3,169,676 by Hanselmann, U.S. Pat. No. 4,248,383 by Savage et al., and U.S. Pat. No. 4,323,266 also by Savage. In each instance in the prior art, a discharge line openly communicates from a fluid portioning chamber to respective nozzles directed at the portion of the vehicle to be washed. In each instance however, no restriction is provided in the discharge line such that in the event that the nozzles are supported at a lower elevation than the fluid portioning chamber, then the contents of the chamber can readily drain so that upon subsequent activation no charge of fluid is ready to be discharged. A further problem arises when the fluid portioning chamber is charged by gravity feed from a fluid supply tank using only a check valve as the fluid portion chamber would be continuously re-filled as it is drained by gravity through the discharge nozzles so that the entire contents of the fluid supply tank may be drained and wasted as well.

### SUMMARY OF THE INVENTION

It is an object of the present invention, to provide a simple, easy to install, low maintenance system, for the effective washing of the headlights while driving.

According to one aspect of the invention there is provided a vehicle washing system for washing a designated surface of a vehicle having a compressed air supply, the system comprising:

a wash fluid tank for containing wash fluid therein;

a charge chamber in communication with the wash fluid and sized to receive a prescribed quantity of wash fluid therein from the wash fluid tank;

a supply line connected to the charge chamber and arranged to communicate with the compressed air supply of the vehicle;

a first control valve connected in series with the supply line;

at least one wash nozzle arranged to be supported on the vehicle so as to be directed onto said designated surface of the vehicle;

a discharge line in communication between the charge chamber and said at least one wash nozzle;

a second control valve connected in series with the discharge line of said at least one wash nozzle; and

the first control valve being operative into an open condition so as to discharge a charge of compressed air from the compressed air supply into the charge chamber; and

the second control valve being operative into an open condition so as to discharge at least a portion of the prescribed quantity of wash fluid from the charge chamber through the nozzles with said charge of compressed air.

By providing a first control valve which controls the charge of compressed air which drives the dispensing of the portioned fluid through the nozzles together with a second valve in series with each nozzle, upon completion of a wash cycle, any fluid remaining in the discharge lines are prevented from draining through the nozzles regardless of the elevation of the nozzles relative to the fluid portioning chamber.

Preferably the second control valve of said at least one wash nozzle is adjacent to the wash nozzle.

When two wash nozzles arranged to be directed on respective designated surfaces of the vehicle, and two discharge lines are connected in parallel with one another between the charge chamber and the two wash nozzles respectively, each discharge line may have one second control valve connected in series therein according to a first embodiment.

Alternatively, there may be provided an outlet line communicating from the charge chamber to a flow splitter such that the two discharge lines are connected in parallel with one another between the flow splitter and the two wash nozzles respectively. In this instance a single second control valve may be connected in series in the outlet line, preferably adjacent to the flow splitter.

Preferably a controller is provided to operate the first and second control valves simultaneously between respective open and closed positions thereof.

Preferably each of the first and second control valves comprises a solenoid operated valve which is in a closed condition until the solenoid operated valve is energized.

Preferably the charge chamber is supported relative to the wash fluid tank so as to be arranged to be filled with wash fluid from the wash fluid tank under force of gravity. In this instance, a check valve is preferably connected in series between the charge chamber and the wash fluid tank such that check valve only opens to permit flow from the wash fluid tank towards the charge chamber.

Preferably a pressure balancing passage is provided in communication between the charge chamber and the wash fluid tank in parallel with the check valve, the pressure balancing passage having a restricted flow capacity relative to an open condition of the check valve.

According to one embodiment, the pressure balancing passage is defined by a pressure balancing line mounted in parallel to the check valve. In this instance the pressure balancing line preferably communicates with the charge chamber adjacent to a top end of the charge chamber and includes a restricted orifice connected in series therewith.

Alternatively, when the check valve comprises a valve body which is operable between an open condition and a closed condition relative to a valve seat, the pressure balancing passage may comprise a port communicating through the valve body in the closed condition of the check valve.

In one preferred embodiment, the designated surface of the vehicle being washed comprises a pair of headlights in which two of the nozzles are supported on the vehicle so as to be directed onto the pair of headlights respectively.

More particularly, according to the illustrated embodiment, a headlight washing system is described herein in which windshield washer fluid from the vehicle's onboard storage tank is introduced into a charge chamber, where compressed air from the vehicle's onboard air system may be applied to the fluid thereby forcing it through a nozzle or nozzles aimed at the lens of the vehicle's headlights. Washer fluid is introduced into the charge chamber through a check valve mounted in the bottom of the fluid holding tank. It is kept from back flowing into the vehicle's air system by another check valve. Finally there is one or more solenoid controlled valves mounted close to the outlet nozzles that open when the system is pressurized by the vehicle's onboard air system. When one wishes to wash the vehicle's headlights, a solenoid controlled valve is opened by a switch mounted in the cab of the vehicle. This allows compressed air from the onboard air system to pressurize the washer fluid charge chamber. At the same time, this switch also opens the solenoid controlled valves mounted near the outlet nozzles, allowing the high pressure fluid to be forced through the nozzles at a high velocity, thereby washing accumulated road spray, frost, ice, etc. from the lens of the headlights. As soon as the system is pressurized the check valve at the bottom of the fluid holding tank closes, to prevent back pressuring of the holding tank. Once the compressed air supply to the washing system has been shut off, the check valve in the air supply line closes to prevent washer fluid from entering the onboard air system. There is however a residual pressure that remains in the charge chamber after all the solenoid controlled valves have been closed, which prevents the check valve in the fluid entry port from reopening to introduce more washer fluid into the system to refill the charge chamber. Therefore an air bleed passage in the form of small orifice communicates in parallel with the check valve to allow the residual pressure to bleed off from the charge chamber to the fluid holding tank (along with a small amount of fluid). This in turn allows the check valve in the fluid entry port to open, refilling the charge chamber with washer fluid for the next wash cycle. The reason for keeping the bleed passage as a small orifice is so that it does not vent excessively while the system is fully pressurized.

Various embodiments of the invention will now be described in conjunction with the accompanying drawings in which:

### BRIEF DESCRIPTION OF THE DRAWINGS

FIG. 1 is a schematic representation of the vehicle light washing system according to a first embodiment;

FIG. 2 is a schematic representation of the washing system supported on a vehicle;

FIG. 3 is a schematic representation of the check valve incorporating a pressure balancing passage therein according to the first embodiment of FIG. 1 and

FIG. 4 is a schematic representation of the vehicle light washing system according to a second embodiment.

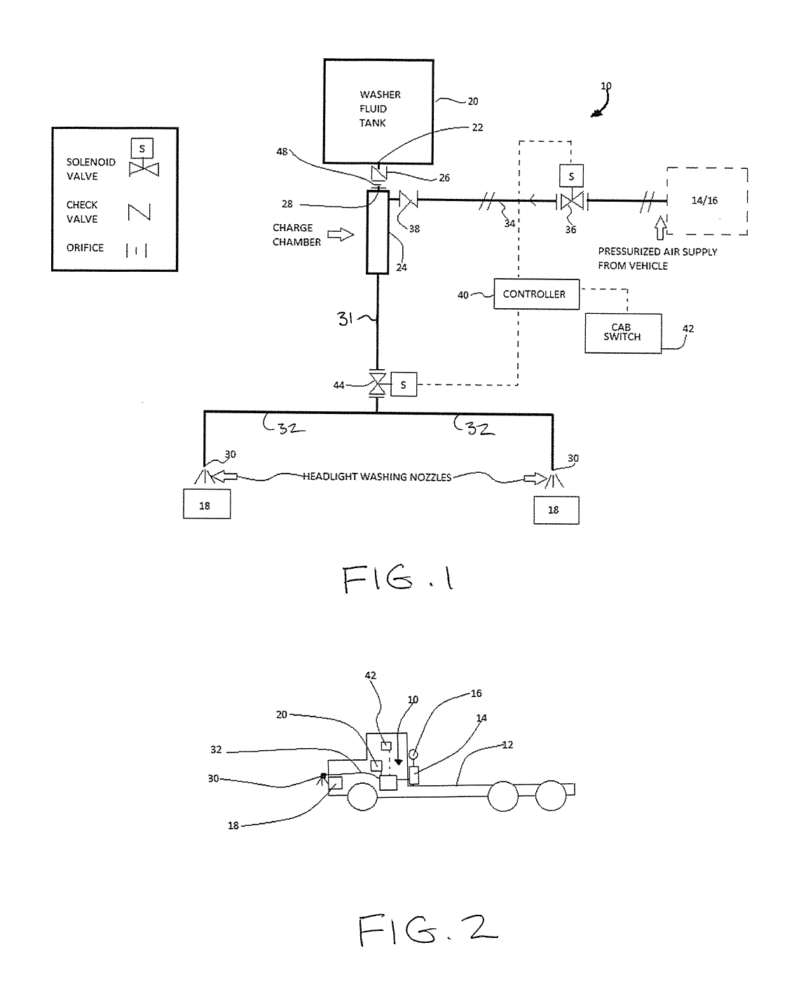

In the drawings like characters of reference indicate corresponding parts in the different figures.

### DETAILED DESCRIPTION

Referring to the accompanying figures, there is illustrated a vehicular lighting wash system generally indicated by reference numeral 10. The system 10 is particularly suited for use with a vehicle 12 of the type including an on-board compressed air supply. The compressed air supply generally comprises a compressed air storage tank 14 which typically provides compressed air to air braking systems of the vehicle and the like, and a compressor 16 which is arranged to supply the compressed air to the tank 14 to maintain a supply of pressure in the tank above a prescribed minimum threshold pressure. The vehicle 12 is further provided with lights 18, for example headlights, taillights and the like.

Although two embodiments are shown in the accompanying figures, the features in common to both embodiments will first be described.

The system 10 may make use of an existing on-board wash fluid tank of the vehicle, or more preferably an auxiliary wash fluid tank 20 supported on the vehicle which contains several charges of wash fluid therein. Each charge of wash fluid comprises a portioned quantity of fluid suitable for use in one complete wash cycle of the system. The fluid tank 20 includes a drain 22 at the bottom end thereof.

The system further includes a charge chamber 24 supported on the vehicle and arranged to receive one or more charges of wash fluid therein for portioning the fluid from the wash fluid tank. The charge chamber 24 is coupled to the drain 22 of the wash fluid tank 20 and is situated lower in elevation than the tank 20 to permit filling of the charge chamber with wash fluid from the tank under force of gravity alone.

A suitable check valve 26 is coupled in series with a fill line 28 which communicates from the drain 22 of the tank to an inlet of the charge chamber 24. A check valve 26 is oriented to allow flow of fluid therethrough from the tank to the charge chamber under gravity for allowing filling of the charge chamber 24 with the respective portioned quantity of fluid corresponding to one wash cycle. The check valve 26 is arranged to be closed however when pressure within the charge chamber 24 exceeds the pressure within the fill line 28 in communication with the wash fluid tank, for example as occurs during active discharging of the charge of wash fluid onto the lights of the vehicle.

In the illustrated embodiments, each of the two headlights of the vehicle is provided with a respective wash nozzle 30 of the system with the wash nozzle being supported relative to the headlights so as to be directed downwardly and rearwardly onto the outer surface of the lens of the headlight.

A discharge line 32 is associated with each nozzle to provide fluid from the charge chamber 24 to the respective nozzles 30. The plurality of discharge lines all communicate equally with the charge chamber such that introduction of a charge of compressed air into the charge chamber 24 during a wash cycle urges a quantity of the fluid in the charge chamber to be evenly distributed among the two discharge lines. The quantity of fluid discharged is dependent upon the length and size of the charge of compressed air released from the supply to the charge chamber. The two discharge lines then convey the corresponding quantity of fluid from the charge chamber to the two nozzles 30 respectively for dispensing the charge of fluid onto the headlights.

The system further includes a supply line 34 which is connected to the supply tank 14 of the vehicle and extends from the supply tank to a top end of the charge chamber 24. A first control valve 36 is coupled in series with the supply line and is situated in proximity to the supply tank 14. The first control valve 36 is solenoid operated and is arranged such that the valve is in a closed state when the solenoid is de-energized.

The supply line 34 also includes a check valve 38 connected in series therewith in proximity to the charge chamber 24 such that any excess pressure in the charge chamber relative to the supply line 34 does not result in wash fluid back-flowing into the supply line as a result of the check valve. The check valve 38 however automatically opens and allows a prescribed charge of compressed air to be communicated from the supply tank 14 to the charge chamber 24 without restriction during a wash cycle.

A controller 40 is supported on the vehicle and is connected to the first control valve 36 to controllably energize the solenoid thereof under direction of the operator of the vehicle. The controller 40 is coupled to an activation switch 42 arranged to be mounted in the cab of the vehicle for ready access by an operator of the vehicle. Upon activation of the cab switch, the controller 40 serves to open the first control valve 36 for a prescribed duration corresponding to one wash cycle, during which a prescribed charge of compressed air is dispensed from the tank 14 on the vehicle to the charge chamber. The charge of compressed air is sufficient to substantially fully discharge the portioned quantity of wash fluid in the charge chamber through the discharge lines and the nozzles 30 respectively onto the headlights of the vehicle.

At the end of the wash cycle, any remaining liquid in the discharge lines or any liquid which is discharged from the wash fluid tank 20 to the charge chamber 24 during re-filling of the charge chamber is prevented from draining out through the discharge lines and the nozzles 30 by one or more second control valves 44 associated with the nozzles.

Each of the second control valves 44 is also solenoid operated and configured to be in a closed position when the solenoid is de-energized. The controller 40 is also coupled to each of the second control valves and operates to open all of the second control valves simultaneously with the first control valve 36 upon activation of the switch 42 by the operator. In a preferred arrangement the controller 40 also closes the second valves simultaneously with the first valves upon expiration of the duration of the wash cycle as determined by the length of time that the control valves are actuated by the operator using a momentary switch, or by a timer element of the controller 40 for example.

Upon closing of the control valves, to ensure that any residual pressure within the charge chamber does not prevent the check valve 26 from opening to allow filling of fluid from the tank 20 to the charge chamber, an additional pressure balancing passage 46 is provided. The pressure balancing passage 46 communicates from the charge chamber to the wash fluid tank 20. At least a portion of the passage 46 is restricted in size relative to the flow capacity of the check valve 26 to provide the function of a restricted orifice in series with the pressure balancing passage, for example having a diameter of approximately 0.020 inches. More particularly, restricted pressure balancing passage is sufficiently small that upon discharging the charge of compressed air from the tank 14 to the charge chamber 24 at the initiation of a wash cycle, a majority of the charge of air is diverted to the discharge lines 32 for driving the discharging of the portioned quantity of fluid from the charge chamber 24 through the nozzles 30.

Upon completion of a prescribed wash cycle however, once the control valves have been closed, any excess pressure within the charge chamber 24 relative to the wash fluid tank is permitted to bleed through the pressure balancing passage 46 so as to equalize pressure between the charge chamber 24 and the wash fluid tank 20. Once the pressures are equalized, gravity is sufficient to open the check valve 26 to permit filling of the charge chamber with wash fluid from the tank 20.

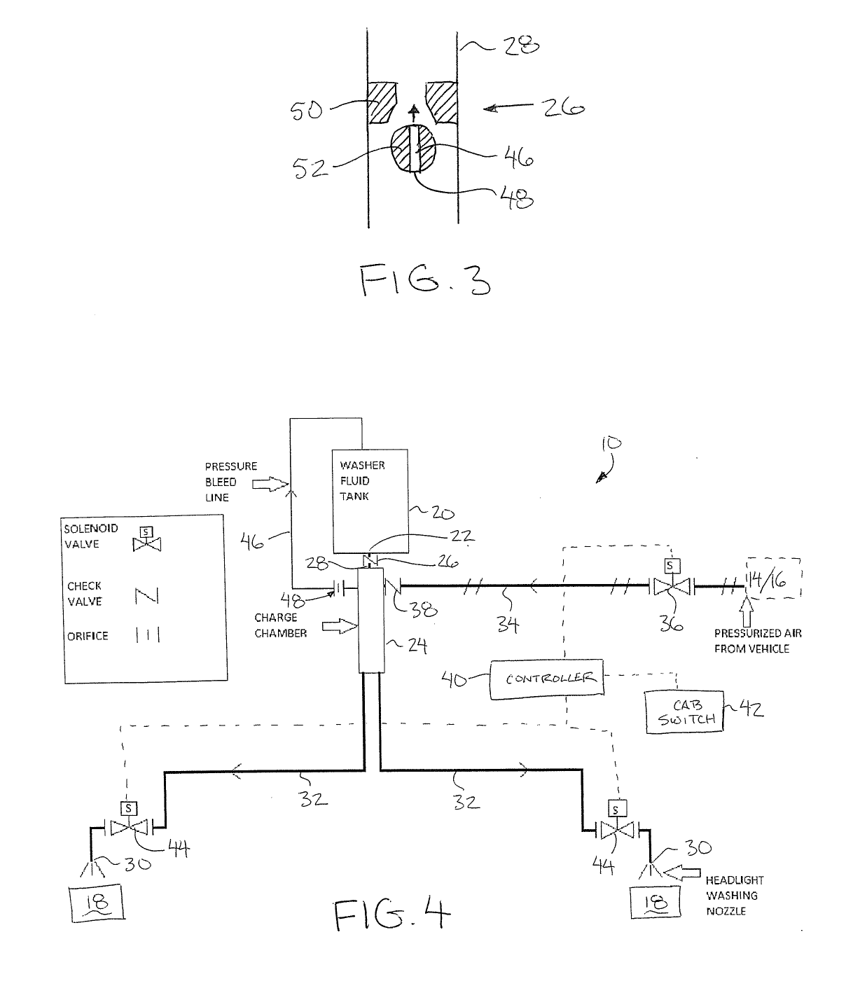

Turning now more particularly to the first embodiment of FIGS. 1 and 3, in this instance an outlet line 31 is provided in communication between the bottom end of the charge chamber 24 and a flow splitter 33. The two discharge lines 32 in this instance communicate in parallel with one another from the flow splitter 33 to the two nozzles 30 respectively. The flow splitter 33 is mounted as close to the two nozzles 30 as possible so as to maximize the length of the outlet line 31 and minimize the length of the two discharge lines 32. In this instance a single second control valve 44 is mounted in series with both discharge lines by being mounted in the outlet line 31 directly adjacent to the flow splitter 33.

As shown schematically in FIG. 3, the check valve 26 is mounted within the fill line 28 communicating between the charge chamber and the wash fluid tank. The check valve 26 includes a valve seat 50 is mounted in the passage of the fill line 28 to define an opening of the check valve therethrough which determines the overall flow capacity of the check valve in an open condition thereof. The check valve also includes a valve body 52 which is movable relative to the valve seat between the open condition and a closed condition seated within the valve seat to prevent flow through the valve opening defined by the valve seat. As in a typical check valve, the valve body 52 is biased towards the closed condition by greater pressure at the charge chamber than at the washer fluid tank side of the valve. The check valve thus only opens to allow flow through under force of gravity of flow of wash fluid from the wash fluid in the tank above to the charge chamber below when pressure is balanced between the charge chamber and the washer fluid tank. When pressure below is greater, the valve is biased to remain closed.

The pressure balancing passage 46 in this instance comprises a port which communicates through the valve body even when the check valve is in the closed condition. The size of the port is restricted relative to the opening in the valve seat 50 such that the port defines a restricted orifice 48 relative to the fill line 28 in the closed position of the check valve 26.

Turning now to the second embodiment of FIG. 4, in this instance the two discharge lines 32 each communicate directly from the bottom of the charge chamber to the respective nozzle 30. The two discharge lines are approximately equal in length to ensure an even discharge of pressurized wash fluid from the charge chamber to the two nozzles 30 respectively. In this instance each nozzle 30 is provided with its own second control valve 44 mounted in series with the associated discharge line at a location in close proximity to the nozzle 30.

According to the second embodiment of FIG. 4, the pressure balancing passage 46 in this instance is provided as a separate bleed line communicating between the top end of the charge chamber and the top end of the washer fluid tank. The bleed line 46 is in parallel with the fill line 28 that communicates between the charge chamber 24 and the fluid tank 20 and which locates the check valve 26 in series therewith. A restricted orifice plate 48 is mounted in series within the bleed line 46 to define the restricted nature of the bleed line relative to the open condition of the check valve 26.

Once installed in a vehicle, the system is initially primed by balancing of the pressure between the charge chamber and the wash fluid tank through the pressure balancing passage to allow gravity filling of the charge chamber from the wash fluid tank 20. To initiate a wash cycle, the operator activates the switch 42 within the cab which causes the controller 40 to open the first and second control valves simultaneously with one another for a prescribed duration, for example either by the user manually activated with the switch for the prescribed duration, or by using a timer which actuates the control valves for the prescribed duration upon initial actuation by the user using the switch 42.

A controlled portion of compressed air, which is proportional to the prescribed duration of activation, is then discharged from the supply tank 14 through the supply line and check valve 38 to drive dispensing of a corresponding portion of wash fluid in the charge chamber through the discharge lines and nozzles evenly relative to one another. The restricted size of the pressure balancing passage ensures that most of the charge of air is diverted through the discharge lines. Furthermore, the restricted size of the pressure balancing passage ensures that pressure in the charge chamber remains elevated relative to the wash fluid tank 20 as long as compressed air is being supplied to the charge chamber to keep the check valve 26 closed until the wash cycle is complete and the control valves are closed. Once the control valves are closed, any excess pressure in the charged chamber relative to the wash fluid tank is balanced by bleeding through the pressure balancing passage to the top of the wash fluid tank. The balanced pressure permits the check valve 26 to again be opened sufficiently to fill the charge chamber 24 with wash fluid from the wash fluid tank. The system is then ready to initiate the next wash cycle upon activation of the switch 42 by the operator in the cab.

Since various modifications can be made in my invention as herein above described, it is intended that all matter contained in the accompanying specification shall be interpreted as illustrative only and not in a limiting sense.

1. A vehicle washing system for washing a designated surface of a vehicle having a compressed air supply, the system comprising:
a wash fluid tank for containing wash fluid therein;
a charge chamber in communication with the wash fluid and sized to receive a prescribed quantity of wash fluid therein from the wash fluid tank;
a supply line connected to the charge chamber and arranged to communicate with the compressed air supply of the vehicle;
a first control valve connected in series with the supply line;
at least one wash nozzle arranged to be supported on the vehicle so as to be directed onto said designated surface of the vehicle;
a discharge line in communication between the charge chamber and said at least one wash nozzle;
a second control valve connected in series with the discharge line of said at least one wash nozzle; and
the first control valve being operative into an open condition so as to discharge a charge of compressed air from the compressed air supply into the charge chamber; and
the second control valve being operative into an open condition so as to discharge at least a portion of the prescribed quantity of wash fluid from the charge chamber through the nozzles with said charge of compressed air.

2. The system according to claim 1 wherein the second control valve of said at least one wash nozzle is adjacent to the wash nozzle.

3. The system according to claim 1 wherein said at least one wash nozzle comprises two wash nozzles arranged to be directed on respective designated surfaces of the vehicle, and wherein there is provided two discharge lines connected in parallel with one another between the charge chamber and the two wash nozzles respectively, each discharge line having one second control valve connected in series therein.

4. The system according to claim 1 wherein said at least one wash nozzle comprises two wash nozzles arranged to be directed on respective designated surfaces of the vehicle, and wherein there is provided an outlet line communicating from the charge chamber to a flow splitter and two discharge lines connected in parallel with one another between the flow splitter and the two wash nozzles respectively, the second control valve being connected in series in the outlet line.

5. The system according to claim 4 wherein the second control valve is mounted in the outlet line adjacent to the flow splitter.

6. The system according to claim 1 further comprising a controller arranged to operate the first and second control valves simultaneously between respective open and closed positions thereof.

7. The system according to claim 1 wherein each of the first and second control valves comprises a solenoid operated valve which is in a closed condition until the solenoid operated valve is energized.

8. The system according to claim 1 wherein the charge chamber is supported relative to the wash fluid tank so as to be arranged to be filled with wash fluid from the wash fluid tank under force of gravity.

9. The system according to claim 8 further comprising a check valve connected in series between the charge chamber and the wash fluid tank such that check valve only opens to permit flow from the wash fluid tank towards the charge chamber.

10. The system according to claim 9 further comprising a pressure balancing passage in communication between the charge chamber and the wash fluid tank in parallel with the check valve, the pressure balancing passage having a restricted flow capacity relative to an open condition of the check valve.

11. The system according to claim 10 wherein the pressure balancing passage is defined by a pressure balancing line mounted in parallel to the check valve.

12. The system according to claim 11 wherein the pressure balancing line communicates with the charge chamber adjacent to a top end of the charge chamber.

13. The system according to claim 11 wherein the pressure balancing line includes a restricted orifice connected in series therewith.

14. The system according to claim 10 wherein the check valve comprises a valve body which is operable between an open condition and a closed condition relative to a valve seat and wherein the pressure balancing passage comprises a port communicating through the valve body in the closed condition of the check valve.

15. The system according to claim 1 in combination with the vehicle wherein the designated surface comprises a pair of headlights and wherein said at least one nozzle comprises a pair of nozzles supported on the vehicle so as to be directed onto the pair of headlights respectively.
